(19) United States
(12) Patent Application Publication
(10) Pub. No.: US 2018/0355944 A1
(43) Pub. Date: Dec. 13, 2018

(54) VIBRATION DAMPER WITH HYDRAULIC DAMPING OF THE PRESSURE STAGE IMPACT

(71) Applicants: THYSSENKRUPP BILSTEIN GMBH, Ennepetal (DE); thyssenkrupp AG, Essen (DE)

(72) Inventors: Christian VELTUM, Iserlohn (DE); Alexandru-marcel MOLDOVAN, Sibiu (RO); Ole GÖTZ, Braunschweig (DE)

(73) Assignees: THYSSENKRUPP BILSTEIN GMBH, Ennepetal (DE); thyssenkrupp AG, Essen (DE)

(21) Appl. No.: 15/775,045

(22) PCT Filed: Nov. 18, 2016
(86) PCT No.: PCT/EP2016/078125

§ 371 Date: May 10, 2018

(30) Foreign Application Priority Data
Dec. 4, 2015 (DE) 10 2015 121 140.8

(51) Int. Cl. F16F 9/49; F16F 9/18; F16F 9/32

(52) U.S. Cl. CPC F16F 9/49; F16F 2228/066; F16F 9/3257; F16F 9/185

(57) ABSTRACT

A vibration damper with hydraulic damping of a pressure stage stop may include a working piston guided in a damper tube along a longitudinal axis. The working piston may be disposed on a piston rod leading out of the damper tube. For damping the pressure stage stop, a tubular body may be disposed in the damper tube, within which an auxiliary piston can be accommodated such that the auxiliary piston is guided along the longitudinal axis. A spring element may pre-stress the auxiliary piston towards the working piston. Upon a drive-in movement of the piston rod into the damper tube, a stop piston that is movable with the working piston comes to lie against the auxiliary piston and together with the auxiliary piston plunges into the tubular body under a hydraulic damping effect and under compression of the spring element. Consequently, a damping agent in the tubular body may flow through the auxiliary and stop pistons. A flow cross-section geometry may be formed in the tubular body, through which the damping agent flows out of the tubular body parallel to a throughflow through the stop piston when the auxiliary piston and the stop piston drive into the tubular body together. The flow cross-section geometry may become smaller as the drive-in path increases.”

The present invention relates to a vibration damper with hydraulic damping of a pressure stage stop, comprising a damper tube and a working piston guided in the damper tube along a longitudinal axis, wherein the working piston is accommodated on a piston rod leading out of the damper tube and wherein, for damping the pressure stage stop, a tubular body is arranged in the damper tube, in which an auxiliary piston is accommodated such that it is guided along the longitudinal axis and in which this auxiliary piston is pre-stressed in the direction towards the working piston by a spring element, and wherein a stop piston which is movable with the working piston is provided, which, upon a drive-in movement of the piston rod into the damper tube, comes to lie against the auxiliary piston and, together with this, plunges into the tubular body under a hydraulic damping effect and under compression of the spring element, whereby a damping agent present in the tubular body is displaced and flows through the auxiliary piston and the stop piston.

### PRIOR ART

WO 2015/105791 A1 discloses a generic vibration damper with hydraulic damping of a pressure stage stop, and the vibration damper comprises a damper tube and a working piston guided in the damper tube along a longitudinal axis. A piston rod leading out of the damper tube is arranged on the working piston and, by means of the piston rod, the working piston can be displaced in the damper tube in the direction of a pressure stage stop. Arranged in a continuation of the piston rod, a stop piston is located on a piston extension of the working piston, which stop piston can be moved with the working piston in the direction towards the pressure stage stop upon a drive-in movement of the piston rod into the damper tube. A tubular body, which extends in the direction of the longitudinal axis, is accommodated in the bottom region of the damper tube, in which tubular body an auxiliary piston is accommodated, which is pre-stressed in the direction towards the working piston, and in particular in the direction towards the stop piston, by a helical spring. If the working piston is moved in the direction towards the pressure stage stop, the stop piston comes to lie against the auxiliary piston in a predetermined drive-in position and, upon a further continued drive-in movement, the stop piston and the auxiliary piston drive into the tubular body together in a stacked arrangement. In this case, the spring element is compressed until the auxiliary piston has finally driven completely into the tubular body. The tubular body is accommodated in a further tubular body so that the drive-in movement continues under compression of a further helical spring, wherein the two tubular bodies are slid inside one another in a telescopic manner.

The compression of the helical springs takes place substantially under a linear increase in force and, in addition to the compression force of the helical springs, the damping takes place as a result of a damping agent flowing through the stop piston. Flow channels are incorporated in the stop piston, through which the damping agent flows during the drive-in movement into the tubular body, and the flow channels are covered by valve spring disks so that a damping effect with a corresponding characteristic is generated via a deflection of the valve spring disks.

As a result of the impact of the stop piston against the auxiliary piston and as a result of the limited spring travel of the first helical spring in the first tubular body, a sudden movement of the first tubular body takes place to produce the telescopic sliding movement into the second tubular body, so that a force/travel progression with a stepped form is generated as a result. However, a characteristic of the pressure stage stop with a substantially continuous increase in the damping force up to the final impact of the pressure stage would instead be desirable.

### DISCLOSURE OF THE INVENTION

The object of the invention is to further develop a vibration damper with hydraulic damping of a pressure stage stop, wherein the aim is to achieve the smoothest possible increase in the damping force up to the final impact in the pressure stage. In this case, the construction effort should be as minimal as possible.

This object is achieved starting with a vibration damper according to the precharacterizing clause of claim 1 in conjunction with the characterizing features. Advantageous further developments of the invention are described in the dependent claims.

The invention includes the technical teaching that at least one flow cross-section geometry is formed in the tubular body, through which the damping agent flows out of the tubular body parallel to the throughflow through the stop piston when the auxiliary piston and the stop piston drive into the tubular body together, wherein the flow cross-section geometry is formed such that the flow cross-section becomes smaller as the drive-in path increases.

The core of the invention is firstly to maintain the arrangement of a stop piston on the piston rod and to arrange a tubular body with an auxiliary piston guided in the tubular body so that the soft characteristic can be set in a simple manner by plating the stop piston accordingly with valve spring disks. Owing to the constant characteristic of the stop piston irrespective of the plunge depth into the tubular body, the invention provides the flow geometry through which the damping agent can flow out of the tubular body parallel to the throughflow through the stop piston. Depending on the drive-in depth of the auxiliary piston together with the stop piston, the flow cross-section geometry varies such that the remaining flow cross-section decreases as the plunge depth of the stop piston together with the auxiliary piston increases. As a result, a continuous or virtually continuous increase in the damping force of the pressure stage stop is produced, wherein, with a fully closed flow cross-section geometry in the tubular body, a remaining residual cross-section is formed through the stop piston. Consequently, the stop piston can be constructed with a correspondingly harder characteristic since, in the manner of a bypass, the damping agent can flow out of the tubular body parallel to the throughflow through the stop piston as a result of the flow cross-section geometry.

As a result, a smoothing of the stepped characteristic of the force progression of the pressure stage stop over the drive-in path is produced, wherein, as a result of simply incorporating the flow cross-section geometry in the tubular body to generate a corresponding pressure stage stop, the construction effort is not substantially increased.

According to a first embodiment of the flow cross-section geometry, this is formed by means of at least one row of holes comprising a plurality of holes passing through the wall of the tubular body. In this case, the row of holes in the wall of the tubular body extends particularly advantageously along or parallel to the longitudinal axis. If the stop piston, together with the auxiliary piston, drives into the tubular body, the number of the remaining holes of the row of holes through which the damping agent can be pressed out of the tubular body reduces as the plunge depth of the piston progresses. The smaller the number of remaining holes, the greater the flow resistance and the higher the damping forces. In this simple manner, the damping force is controlled solely by the movement of the pistons within the tubular body, wherein an increasing plunge depth of the pistons into the tubular body essentially leads to an increased damping force. If the pistons withdraw from the tubular body again, the damping agent arrives back in the interior region of the tubular body again through the stop piston and through the holes of the row of holes which are increasing in number again.

Further advantageously, the holes of the row of holes are formed identically to one another or it is provided that, successively in the direction of the longitudinal axis, the holes of the row of holes have a varying cross-section or are at different spacings from one another. The variation in the remaining outflow cross-section for the damping agent from the interior region of the tubular body as the piston drives in further does not necessarily have to be linear, which means that a progressive or diminishing rise in the damping force can be set via the geometry, the number and/or the mutual spacings of the holes.

Further advantageously, a plurality of rows of holes can be provided, distributed over the circumference of the tubular body, wherein the tubular body is preferably constructed with rows of holes in such a way that a perforated grid-like tubular body is produced.

According to a further possible embodiment for forming the flow cross-sections, these can be formed by means of at least one cross-sectionally varying groove in the inside wall of the tubular body. In a manner similar to holes formed in a row of holes, the cross-sectional variation in a flow groove in the inside wall of the tubular body can also be used for varying a remaining outflow geometry for the damping agent from the interior region of the tubular body as the plunge depth of the piston into the tubular body varies. The damping force becomes greater as the groove which forms a closed cross-section contour with the auxiliary piston becomes smaller, so that the groove becomes smaller in the direction of a progressing plunge depth of the auxiliary piston. It is particularly possible to incorporate a plurality of grooves in the inside wall, distributed over the circumference of the tubular body.

By way of example, the cross-sectionally varying groove in the inside wall of the tubular body therefore becomes deeper and/or wider towards a free end of the tubular body. Alternatively, the number of grooves in the inside wall of the tubular body can also vary over the longitudinal direction of the tube.

According to a preferred embodiment, the vibration damper has a bottom valve which is arranged in the bottom accommodating region of the tubular body. It is moreover preferably provided that the tubular body is designed such that it is closed towards the bottom valve and that the bottom valve is inflowable by the damping agent from a circumferential gap between the tubular body and the damper tube. Particularly advantageously, the vibration damper is designed as a twin-tube damper with an inner tube and with an outer tube, wherein the inner tube forms the damper tube described above.

### PREFERRED EXEMPLARY EMBODIMENT OF THE INVENTION

Further measures improving the invention are illustrated in more detail below together with the description of a preferred exemplary embodiment of the invention with reference to the figures, which show:

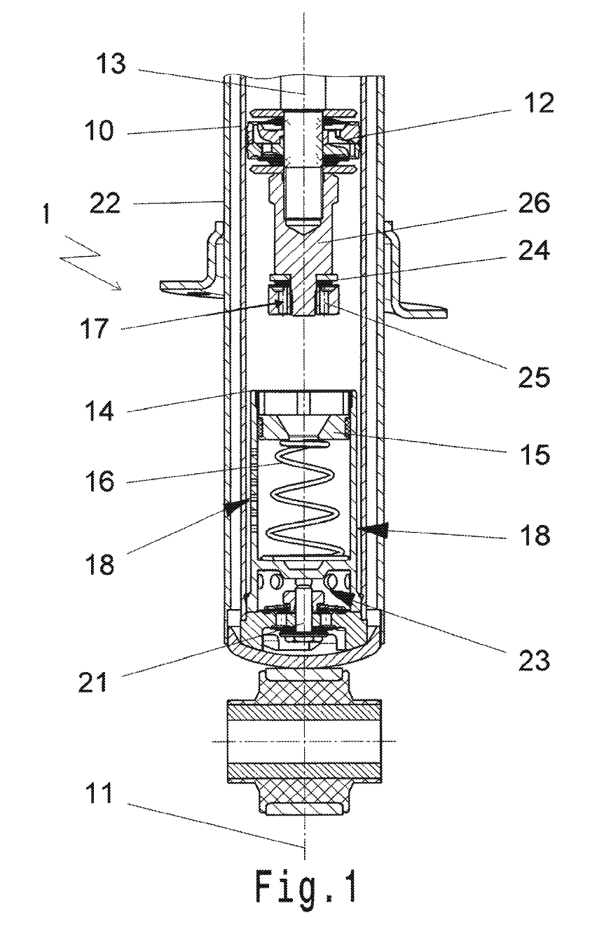

FIG. 1 a cross-sectional view of a vibration damper with hydraulic damping of the pressure stage stop;

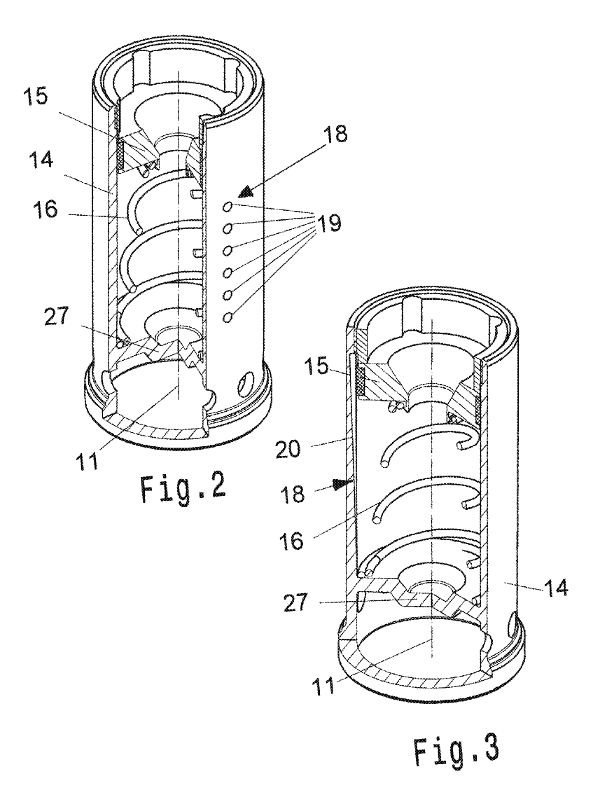

FIG. 2 a perspective illustration of the tubular body with a cross-section geometry which is formed by a row of holes; and

FIG. 3 a perspective illustration of the tubular body with a flow cross-section geometry which is formed by a cross-sectionally varying groove.

FIG. 1 shows, in a cross-sectional view, a vibration damper 1 with a damper tube 10 and with a working piston 12 guided in the damper tube 10 along a longitudinal axis 11. The working piston 12 is accommodated on a piston rod 13 leading out of the damper tube 10, wherein, for damping the pressure stage stop, a tubular body 14 is arranged in the damper tube 10. An auxiliary piston 15 is incorporated in the tubular body 14, which auxiliary piston is annular in design and comprises a central passage. A spring element 16 is inserted in a pre-stressed manner between the auxiliary piston 15 and the bottom region of the tubular body 14, wherein the spring element 16 is formed by a helical spring. In this case, the spring element 16 pre-stresses the auxiliary piston 15 to prevent an impact against the free end of the tubular body 14, which means that the auxiliary piston 15 is pre-stressed towards the working piston 12.

The tubular body 14 has a closed bottom region, wherein flow openings 23, through which a bottom valve 21 arranged below the tubular body 14 is inflowable, are incorporated below the bottom region. The inflow takes place via an annular gap between the outside of the tubular body 14 and the inside of the damper tube 10, so that the damping agent can flow from the annular gap through the flow openings 23 in the lower section of the tubular body 14 to the bottom valve 21. The vibration damper 1 is designed as a twin-tube damper and comprises an inner tube which is formed by the damper tube 10, and the damper tube 10 is surrounded by an outer tube 22. The annular gap between the two tubes 10 and 22 can therefore communicate fluidically with the interior region of the damper tube 10 via the bottom valve 21.

A piston extension 26, on which a stop piston 17 is arranged at the end, is arranged on the working piston 12. The stop piston 17 comprises flow channels 25 which extend axially and the flow channels 25 are covered at the top end with valve spring disks 24.

If the piston rod 13 is driven into the damper tube 10 in the pressure stage, the stop piston 17 moves together with the working piston 12 in the direction towards the tubular body 14. At a predetermined plunge depth of the piston rod 13 into the damper tube 10, the working piston 17 comes to lie with its end face against the auxiliary piston 15. Upon a continued plunge movement, the stop piston 17 together with the auxiliary piston 15 then move into the tubular body 14 in a stacked arrangement and displace a damping agent, for example a damper oil, accommodated in the tubular body 14. As a result of the displacement of the damping agent from the tubular body 14, this flows through the open interior region of the auxiliary piston 15 and the flow channels 25 of the stop piston 17 which pass through the stop piston 17 in the longitudinal-axis direction corresponding to the longitudinal axis 11. The stop piston 17 has valve spring disks 24 at its top end, which are constructed with a soft characteristic and enable the damping agent to flow through the stop piston 17 from the tubular body 14.

In addition to flowing through the stop piston 17, the damping agent from the tubular body 14 arrives from the interior region via flow cross-section geometries 18 incorporated in the tubular body 14. The flow cross-section geometries 18 are constructed in various ways, as explained in more detail by the examples of the following FIGS. 2 and 3.

FIG. 2 shows a perspective view of the tubular body 14 with the auxiliary piston 15 accommodated such that it is guided in the tubular body 14. This auxiliary piston is pre-stressed in an upper end position by a spring element 16 which extends in a pre-stressed manner between a bottom region 27 of the tubular body 14 and the auxiliary piston 15 and is constructed as a helical spring.

By way of example, a row of holes 19 is incorporated in the wall of the tubular body 14, which row of holes comprises a plurality of holes which form a flow cross-section geometry 18 for discharging damping agent which is incorporated in the tubular body 14. In this case, only one row of holes 19 is shown, wherein it is also possible to incorporate a plurality of rows of holes 19 distributed over the circumference of the tubular body. The row of holes 19 extends along the longitudinal axis 11 of the tubular body 14, which coincides with the longitudinal axis 11 of the vibration damper 1.

If, through the drive-in movement of the stop piston 17, the auxiliary piston 15 is driven along the longitudinal axis 11 into the tubular body 14 so that the auxiliary piston 15 moves nearer to the bottom region 27, the spring element 16 is compressed, wherein the damping agent accommodated in the tubular body 14 flows out through the holes of the row of holes 19. As a result of the auxiliary piston 15 moving over the row of holes 19 on the inside, the number of holes reduces as the auxiliary piston 15 drives further into the tubular body 14, whereby the overall flow resistance for the outflow of the damping agent from the tubular body 14 is increased and whereby an increase in the damping force of the pressure stage stop is also achieved.

FIG. 3 shows a further exemplary embodiment of the tubular body 14 with a flow cross-section geometry 18 which is formed by a cross-sectionally varying groove 20 in the inside wall of the tubular body 14. If the auxiliary piston 15 moves along the longitudinal axis 11 in the direction towards the bottom region 27 under compression of the spring element 16, the flow cross-section remaining between the outside of the auxiliary piston 15 and the incorporated groove 20 varies owing to the cross-sectional variation of the groove 20 itself. As a result of the groove 20 becoming smaller in the direction towards the bottom region 27, the remaining flow cross-section also becomes smaller, whereby the flow resistance for the outflow of the damping agent from the interior region of the tubular body 14 increases. This is likewise associated with an increase in the hydraulic damping force in the pressure stage when the piston rod 13 is driven deeper into the damper tube 10 to achieve a corresponding damping effect.

In terms of its construction, the invention is not restricted to the preferred exemplary embodiment described above. Instead, a number of variants is conceivable, which also makes use of the illustrated solution in embodiments which are essentially different in nature. All of the features and/or advantages revealed in the claims, the description or the drawings, including structural details or spatial arrangements, can be essential to the invention both on their own and in a wide variety of combinations.

### LIST OF REFERENCE SIGNS

1 Vibration damper

10 Damper tube

11 Longitudinal axis

12 Working piston

13 Piston rod

14 Tubular body

15 Auxiliary piston

16 Spring element

17 Stop piston

18 Flow cross-section geometry

19 Row of holes

20 Groove

21 Bottom valve

22 Outer tube

23 Flow opening

24 Valve spring disk

25 Flow channel

26 Piston extension

27 Bottom region

1.-10. (canceled)

11. A vibration damper with hydraulic damping of a pressure stage stop, the vibration damper comprising:
a damper tube;
a working piston guided in the damper tube along a longitudinal axis, wherein the working piston is disposed on a piston rod leading out of the damper tube;
a tubular body disposed in the damper tube for damping the pressure stage stop, the tubular body including a flow cross-section geometry;
an auxiliary piston disposed in the tubular body such that the auxiliary piston is guided along the longitudinal axis, wherein the auxiliary piston is pre-stressed in the tubular body in a direction towards the working piston by a spring element; and
a stop piston that is movable with the working piston, wherein upon a drive-in movement of the piston rod into the damper tube the stop piston comes to lie against the auxiliary piston and together with the auxiliary piston plunges into the tubular body under a hydraulic damping effect and under compression of the spring element, whereby a damping agent present in the tubular body is displaced and flows through the auxiliary piston and the stop piston, wherein the damping agent flows through the flow cross-section geometry out of the tubular body parallel to a throughflow through the stop piston when the auxiliary piston and the stop piston drive into the tubular body together, wherein the flow cross-section geometry is formed such that the flow cross-section geometry becomes smaller as a path of the drive-in movement increases.

12. The vibration damper of claim 11 wherein the flow cross-section geometry comprises a row of holes that includes a plurality of holes that pass through a wall of the tubular body.

13. The vibration damper of claim 12 wherein the plurality of holes of the row of holes extends along the longitudinal axis.

14. The vibration damper of claim 12 wherein the plurality of holes of the row of holes are identical to one another.

15. The vibration damper of claim 12 wherein successively in a direction of the longitudinal axis the plurality of holes of the row of holes have varying cross sections.

16. The vibration damper of claim 12 wherein successively in a direction of the longitudinal axis the plurality of holes are spaced apart differently from one another.

17. The vibration damper of claim 11 wherein the flow cross-section geometry comprises a plurality of rows of holes that are distributed over a circumference of the tubular body, wherein each of the plurality of rows of holes includes a plurality of holes that pass through a wall of the tubular body.

18. The vibration damper of claim 11 wherein the flow cross-section geometry comprises a cross-sectionally varying groove in an inside wall of the tubular body.

19. The vibration damper of claim 18 wherein the cross-sectionally varying groove in the inside wall of the tubular body becomes at least one of deeper or wider towards a free end of the tubular body.

20. The vibration damper of claim 11 comprising a bottom valve disposed in a bottom accommodating region of the tubular body.

21. The vibration damper of claim 20 wherein the tubular body is closed towards the bottom valve, wherein the bottom valve is inflowable by the damping agent from a circumferential gap between the tubular body and the damper tube.

22. The vibration damper of claim 11 configured as a twin-tube damper with an inner tube and an outer tube, wherein the inner tube is configured as the damper tube.
